(19) United States
(12) Patent Application Publication
(10) Pub. No.: US 2009/0223264 A1
(43) Pub. Date: Sep. 10, 2009

(54) Locking Cylinder for Functions Especially Performed on Vehicles

(75) Inventors: Ralf Lennhoff, Hagen (DE); Mensur Velicanin, velbert (DE); Lars Gabriel, Velbert (DE); Stefan Mönig, Schwelm (DE); Mario Christensen, Mühlheim a.d. Ruhr (DE)

Correspondence Address: FRIEDRICH KUEFFNER, 317 MADISON AVENUE, SUITE 910, NEW YORK, NY, 10017, US

(73) Assignee: HUF HÜLSBECK & FÜRST GMBH & CO. KG, Velbert (DE)

(21) Appl. No.: 11/991,615

(22) PCT Filed: Sep. 7, 2006
(86) PCT No.: PCT/EP2006/008708

§ 371 Date: Mar. 7, 2008

(30) Foreign Application Priority Data
Sep. 7, 2005 (DE) 10 2005 042 350.7

(51) Int. Cl. E05B 65/12; E05B 31/00; E05B 15/12

(52) U.S. Cl. 70/356; 70/422

(57) ABSTRACT

A locking cylinder comprises a two-part housing, comprising an upper part and a lower part. A cylinder core (20) is received in said housing and can be actuated by turning a key. The housing of the locking cylinder is fastened to the body of a vehicle (34) by fastening means (30). The aim of the invention is to reduce the space required by and simplify handling of the locking cylinder. For this purpose, the fastening means (30) used to fasten (34) the housing of the locking cylinder on the body is also used as a connecting means for fastening the housing upper part on the housing lower part.

The invention concerns a locking cylinder of the type specified in the introductory clause of Claim 1.

An important area of application of locking cylinders of this type is their use in vehicle doors or hatches. The functions arising in this case are the securing and releasing of the doors and hatches. This is intended to bar access to the vehicle by unauthorized persons. However, authorized persons have a key that is assigned to the locking cylinder and is inserted in a key slot of the cylinder core and thereby moves the spring-loaded tumblers into the cylinder core. The cylinder core can then be moved by means of the key from a home position to various operating positions. The upper and lower parts of the housing enclose the cylinder core and all other components inside the housing. At one end of the joined housing parts, the key slot is accessible to the key, while a driver is rotatably supported at the other end. The driver transmits a rotation of the cylinder core via a connecting rod to the functional parts in the vehicle located behind the locking cylinder.

In the previously known locking cylinder of the type specified in the introductory clause of Claim 1, the two parts of the housing, together with the components they hold, must be held together by pins. When the two parts of the housing have to be separated from each other, e.g., to replace a defective component, the removal of the spiral pin is a laborious operation. In addition, points of application for the fastening means must be provided on the housing, by which the housing can be mounted on the body of the vehicle. This is time-consuming and takes up too much space.

The objective of the invention is to develop a locking cylinder of the type specified in the introductory clause of Claim 1, which avoids the disadvantages mentioned above. This objective is achieved by the measures specified in Claim 1, which have the following special significance.

In the invention, the fastening means for mounting the housing on the body has a dual function. The first, customary, function consists in mounting the locking cylinder on the body. However, the second function is to utilize the fastening means at the same time as joining means for fastening the upper part of the housing to the lower part of the housing. A single fastening device and a single handling are thus sufficient for realizing several functions in the locking cylinder at the same time. This saves space and assembly time. At the same time, the possible separation of the two parts of the housing is very simple, because then it is necessary to release only the one fastening device. This allows not only the locking cylinder to be detached from the body but also the housing to be separated into its two parts. This allows access to the components enclosed inside the housing.

Further measures and advantages of the invention are revealed in the dependent claims, the description below, and the accompanying drawings, which illustrate a specific embodiment of the invention.

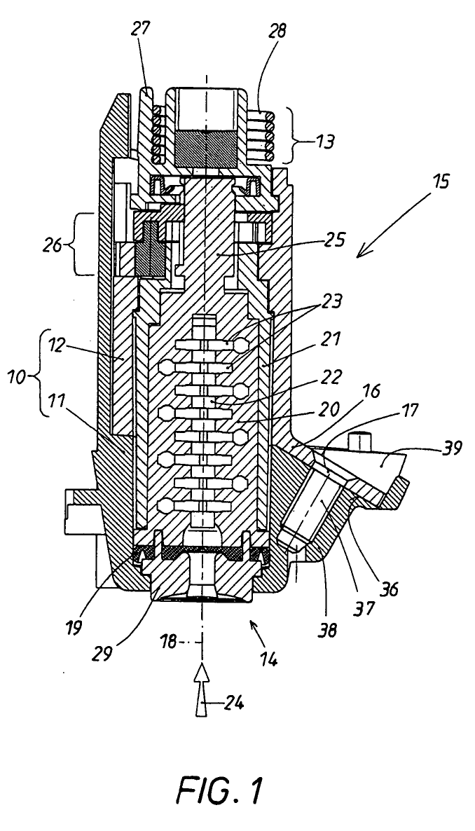

FIG. 1 shows an axial section through an assembled locking cylinder before it is mounted on the body of the vehicle.

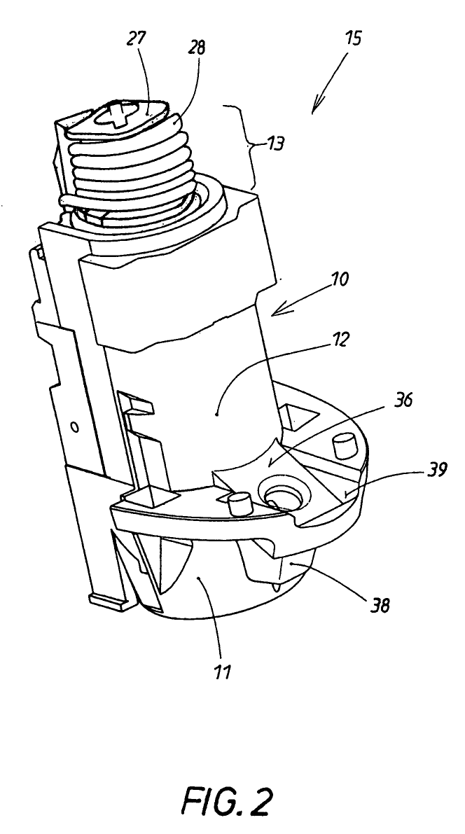

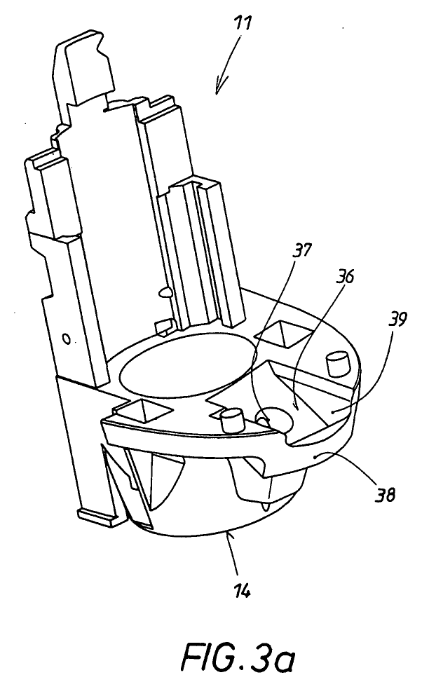

FIG. 2 shows a perspective view of the locking cylinder shown in FIG. 1.

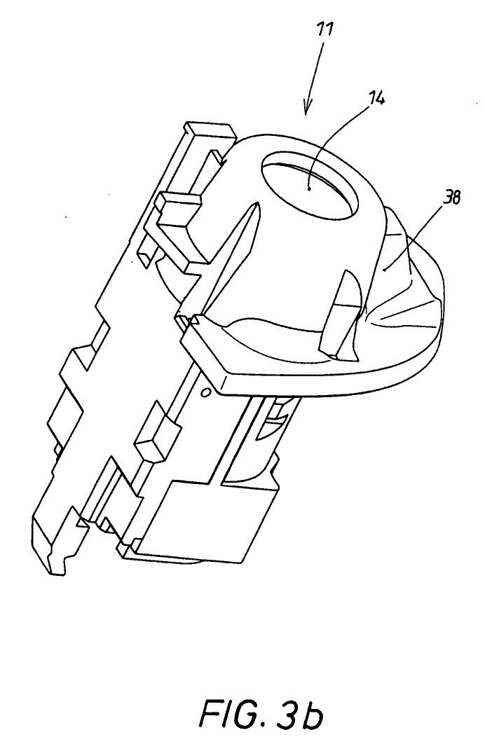

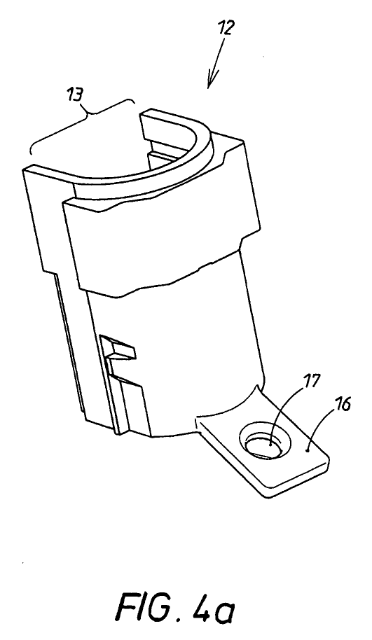

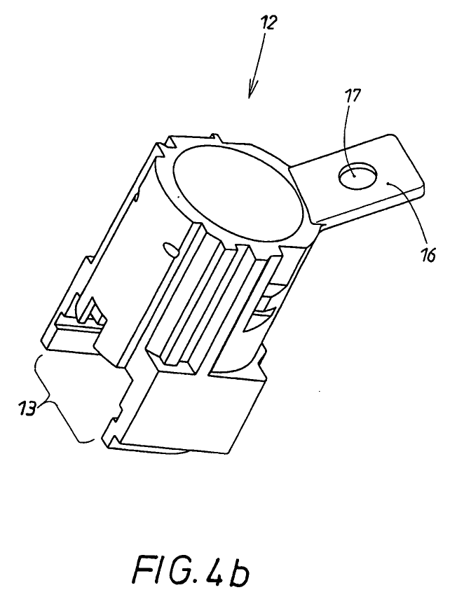

FIGS. 3a and 4a, on the one hand, and FIGS. 3b and 4b, on the other hand, show two oppositely directed perspective views of the upper part of the housing and the lower part of the housing of the locking cylinder of FIG. 1 before they are joined to each other and before the other components are installed inside the housing.

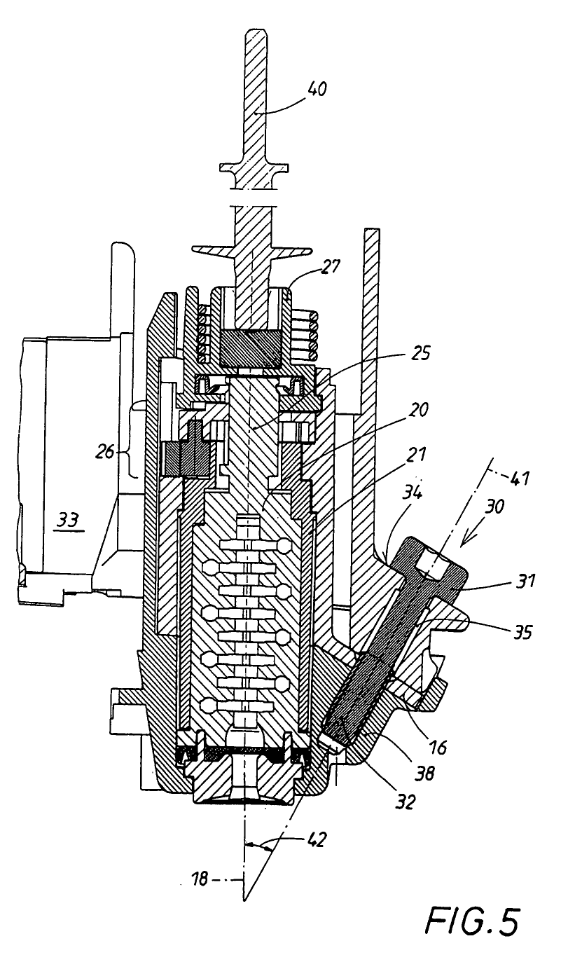

FIG. 5 shows an axial section, analogous to FIG. 1, through the locking cylinder mounted on the body of the vehicle.

As is best seen in FIG. 1, the housing 10 of the locking cylinder consists of two housing parts 11, 12, whose appearance is revealed by the perspective views in FIGS. 3a to 4b. To make it easier to distinguish the two parts of the housing, the housing part 11 that faces the user will be referred to as the “lower part”, and the housing part 12 will be referred to as the “upper part”. The two parts 11, 12 of the housing 10 enclose a large number of components, which in the assembled state constitute a preassembled unit 15, as shown in FIG. 1.

These components within the housing 10 include above all a cylinder core 20, which is rotatably supported inside a free-running sleeve 21. The free-running sleeve 21 is normally at rest in the housing 10. The cylinder core 20 has an axial key slot 22, which is traversed by several chambers 23. The chambers 23 serve to hold spring-loaded tumblers, whose ends, which are not seen in the drawing, fit into at least one axial groove of the free-running sleeve 21. The cylinder core 20 is then rotationally secured.

To release the cylinder core 20 for rotation, an associated key (not shown) must be inserted in the key slot 22 in the direction indicated by the arrow 24. The key then moves the tumblers flush with the cross section of the cylinder core 20. The ends of the tumblers than no longer engage the groove of the free-running sleeve 21, and the cylinder core 20 can be turned by the inserted key.

When the key is turned, the torque is transmitted from a terminal output end 25 of the cylinder core 20, via a free-running device 26 that comprises several components, to a driver 27, which is located at the inner outlet 13 of the housing 10. A pulse spring 28, which works to hold the driver 27 in a well-defined home position, normally also acts on the cylinder core 20. In the normal case, when the free-running sleeve 21 is at rest, the cylinder core 20 is also kept in this home position via the free-running device 26.

An armored faceplate 29 is mounted in front of the outer outlet 14 of the housing 10 and is nonrotatably joined with the cylinder core 20 by means of pins and recesses. An elastomer disk 19 is installed between the faceplate 29 and the cylinder core 20. The faceplate 29 defines the insertion hole for the key and is shaped to conform to the cross section of the key. The elastomer disk 19 has a sealing function and at the same times serves as a shock absorber for forceful blows made in the direction of insertion arrow 24 in an attempt to break into the vehicle.

As is best seen from the detail views of FIGS. 4a and 4b, the upper housing part 12, which is partly shaped like a sleeve, is provided with a tab 16 with a hole 17. As FIG. 1 shows, in the assembled state, the tab 16 extends obliquely to the axis 18 of the locking cylinder and thus the cylinder core 20. The axis 18 is indicated by a dot-dash line in FIG. 1.

FIGS. 3a and 3b show the appearance of the upper part 12 of the housing. As is also apparent from the axial section in FIG. 1, the upper part 12 has a lateral housing extension 38 with a recess 39, whose base region forms a mating part 36 for the tab 16. The housing extension 38 is provided with a threaded receptacle 37.

When the unit 15 of FIG. 1 is being assembled, the two housing parts 11, 12 can be temporarily held together by locking means and their mating devices, which are not shown in the drawing. However, this type of locking is obtained above all when, as FIG. 1 illustrates, the tab of the housing lower part 12 fits into the recess 39 of the housing extension 38 of the housing lower part 11. The final connection between the two housing parts 11, 12 is realized in the present case by fastening means 30, which mount the locking cylinder on the body 33 of the vehicle. This will be explained in greater detail in connection with FIG. 5.

FIG. 5 shows a portion of a body 33 of a vehicle, such as a vehicle hatch, which is to be equipped with the locking cylinder. The fastening means consists of a bolt 30. The body 33 has a well-defined mounting location 34 for the locking cylinder. A hole 35 for the bolt 30 is provided there. In the fastened state, the shaft of the bolt 30 passes through the hole 35 and the tab 16 in the housing upper part 12, while the threading 32 of the bolt engages the aforementioned threaded receptacle 37 of the housing extension 38. The head 31 of the bolt 30 rests against the upper side of the body mounting location 34. In the fastened state shown in FIG. 5, the axis 41 of the bolt 30, which is indicated by a dot-dash line, extends at an acute angle 42 to the axis 18 of the cylinder core 20.

In the fastened state shown in FIG. 5, the driver 27 of the locking cylinder is connected by a rotary joint 40 with those units in the vehicle which are to carry out the desired functions in the vehicle when the locking cylinder is actuated by being turned. In the present case, the rotary joint 40 is intended to connect the driver with a lock in the hatch of the vehicle. This lock can be switched between a secured position and a released position. It goes without saying that the driver could also be used to actuate any other desired functions in the vehicle.

In the event of a forceful rotation of the cylinder core with burglary tools by unauthorized persons, the cylinder core 20 remains engaged with the free-running sleeve 21 by the aforementioned outwardly projecting ends of the tumblers. A catch between the free-running sleeve 21 and the housing 10 is then released, and the cylinder core 20 rotates inside the housing along with the free-running sleeve 21. During forced rotation, the free-running device 26 decouples the driver 27 relative to the terminal output end 25 of the cylinder core 20. Therefore, despite the forceful rotations by means of the burglary tool, the driver 27 and thus the rotary joint 40 connected with it remain at rest, and so no function is carried out in the vehicle.

### LIST OF REFERENCE NUMBERS

10 housing
11 lower part of 10
12 upper part of 10
13 inner outlet of 10
14 outer outlet of 10
15 unit
16 tab on 12
17 hole in 16
18 axis of the locking cylinder
19 elastomer disk
20 cylinder core
21 free-running sleeve
22 key slot
23 chamber
24 arrow indicating the direction of insertion of the key
25 terminal output end
26 free-running device
27 driver
28 pulse spring
29 faceplate
30 fastening means, bolt
31 head of 30
32 threading of 30
33 body of the vehicle
34 mounting location on 33
35 hole in 34
36 mating part for tab 16 on 38
37 threaded receptacle in 38
38 housing extension on housing part 11
39 recess in 38 for 36
40 rotary joint at 27
41 axis of 30
42 acute angle between 41, 18

1. A locking cylinder for functions that can be performed in a vehicle,
with a cylinder core (20), which has an axial key slot (22) for inserting an associated key and radially moving, spring-loaded tumblers that interact with the key,
with a two-part housing (10) that comprises an upper part (12) and a lower part (11) and serves to rotatably support the cylinder core (20),
the upper part (12) has a projecting tab (16) with a first hole (17), and the lower part (11) has a part (36) that mates with the tab (16) and that has a second hole (37),
the upper part (12), the cylinder core (20) and the lower part (11) constitute a preassembled unit (15), in which the tab (16) rests directly against its mating part (16), and the two holes (17, 37) are aligned,
with a bolt fastening means (30), which passes, on the one hand, through a hole (35) in a body (33) of the vehicle and, on the other hand, through the two holes (17, 37) of the unit (15),
the bolt fastening means (30) not only bolts together all of the components (12, 20, 11) of the unit (15) but also bolts the unit (15) to the body (33).

2. A locking cylinder in accordance with claim 1, wherein locking means and their mating devices are provided between the upper part (12) and the lower part (11) of the housing (10) and serve to temporarily hold together the two housing parts (11, 12).

3. A locking cylinder in accordance with claim 1, wherein that the hole in the mating part (36) of the lower part (11) of the housing (10) consists of a threaded receptacle (37), into which the threaded end (32) of the bolt (30) is screwed in the mounted state.

4. A locking cylinder in accordance with claim 3, wherein the mating part (36) is formed from a lateral housing extension (38) of the housing lower part (11).

5. A locking cylinder in accordance with claim 1, wherein the axis (41) of the bolt (30) forms an acute angle (42) with the axis (18) of the locking cylinder.

6. A locking cylinder in accordance with claim 1, wherein the mounting location (34) on the body (33), which has the hole (35), as well as the tab (16) and the mating part (36) of the two housing parts (12, 11) extend at an inclination to the axis (18) of the cylinder core (20).

7. A locking cylinder in accordance with claim 1, wherein the locking cylinder is rotatably supported in a free-running sleeve (20), which is normally at rest; that a free-running device (26) is installed between a terminal output end of the cylinder core (20) and a driver (27) at the outlet (25) of the housing; and that, under normal conditions, when the cylinder core (20) is turned by the key, the free-running device (26) transmits the torque of the locking cylinder to the driver (27), but that, under overload conditions, the free-running device (26) decouples the driver (27) from the cylinder core (20) when a burglary tool causes the cylinder core (20) to undergo forceful rotation that exceeds a well-defined limit torque of the free-running device (26).
